(19) United States
(12) Patent Application Publication
(10) Pub. No.: US 2020/0079597 A1
(43) Pub. Date: Mar. 12, 2020

(54) METHOD AND APPARATUS FOR DISTANCING ADJACENT TILES

(71) Applicant: KA-Dynamic Color Ltd., Tzur-Yigal (IL)

(72) Inventors: Arnon KRAEMER, Zikhron-Yaakov (IL); Oron SHINAR, Yagur (IL); Avi SKOVLEVITZ, Kiryat Ono (IL)

(73) Assignee: KA-Dynamic Color Ltd., Tzur-Yigal (IL)

(21) Appl. No.: 16/561,123

(22) Filed: Sep. 5, 2019

Related U.S. Application Data
(60) Provisional application No. 62/727,609, filed on Sep. 6, 2018.

(51) Int. Cl. B65G 47/90

(52) U.S. Cl. CPC B65G 47/90

(57) ABSTRACT

A system including a first tile, an actuator mechanically connected to the first tile, and a mechanical link mechanically connecting the first tile to a second tile, wherein the mechanical link is configured to allow the actuator to move the first tile a first distance in a first direction without causing the second tile to move, and to cause the second tile to move in the first direction when the first tile is moved in the first direction further than the first distance. A method for withdrawing a tile from an array of tiles including moving a first tile a first distance in a first direction without causing a second, adjacent tile to move, thereby distancing the first tile from the second tile, and withdrawing the first tile from a front face of the array of tiles. Related apparatus and methods are also described.

### RELATED APPLICATION

This application claims the benefit of priority under 35 USC 119(e) of U.S. Provisional Patent Application No. 62/727,609 filed Sep. 6, 2018, the contents of which are incorporated herein by reference in their entirety.

### FIELD AND BACKGROUND OF THE INVENTION

The present invention, in some embodiments thereof, relates to distancing adjacent tiles and, more particularly, but not exclusively, to distancing adjacent overlapping tiles.

Additional background art includes International Patent Application No. WO 2013/144956.

The disclosures of all references mentioned above and throughout the present specification, as well as the disclosures of all references mentioned in those references, are hereby incorporated herein by reference.

### SUMMARY OF THE INVENTION

The present invention, in some embodiments thereof, relates to distancing adjacent tiles and, more particularly, but not exclusively, to distancing adjacent overlapping tiles. Distancing adjacent tiles, producing a space between the adjacent tiles, potentially enables accessing the tiles for one or more purposes, including, by way of some non-limiting examples, maintenance of the tiles, maintenance of a space of a mechanism covered by the tiles, and extracting one or more tiles.

The term “array” in all its grammatical forms is used throughout the present specification and claims to mean either a one dimensional array or a two dimensional array.

According to an aspect of some embodiments of the present invention there is provided a system including a first tile, an actuator mechanically connected to the first tile, and a mechanical link mechanically connecting the first tile to a second tile, wherein the mechanical link is configured to allow the actuator to move the first tile a first distance in a first direction without causing the second tile to move, and to cause the second tile to move in the first direction when the first tile is moved in the first direction further than the first distance.

According to some embodiments of the invention, the actuator is mechanically connected to a first rod, and the first rod is connected to the first tile.

According to some embodiments of the invention, further including a second rod and wherein the mechanical link mechanically connects the first rod to the second rod.

According to some embodiments of the invention, further including a third rod and a second mechanical link, and wherein the third rod is connected to a third tile, the second mechanical link mechanically connects the second rod to the third rod, and the second mechanical link is configured to allow the second rod to move the second tile a second distance in the first direction without causing the third rod to move, and to cause the third rod to move in the first direction when the second rod is moved in the first direction further than the second distance.

According to some embodiments of the invention, the first tile includes a plurality of tiles and the second tile includes a plurality of second tiles.

According to some embodiments of the invention, the third tile includes a plurality of tiles.

According to some embodiments of the invention, at least the first tile includes a module in an array of display modules in a display system.

According to some embodiments of the invention, at least the first tile includes a pixel in an array of pixels in a display system.

According to an aspect of some embodiments of the present invention there is provided a method for withdrawing a tile from an array of tiles including moving a first tile a first distance in a first direction without causing a second, adjacent tile to move, thereby distancing the first tile from the second tile, and withdrawing the first tile from a front face of the array of tiles.

According to some embodiments of the invention, further including additionally moving the second tile in the first direction, causing the second tile to move in the first direction without causing a third, adjacent tile to move, thereby distancing the second tile from the third tile, and withdrawing the second tile from the front face of the array of tiles.

According to some embodiments of the invention, the first tile includes a first row of tiles, the second tile includes a row of second row of tiles, and the withdrawing the first tile from a front face of the array of tiles includes withdrawing at least one tile from the first row of tiles.

According to some embodiments of the invention, the first tile includes a first row of tiles, the second tile includes a row of second row of tiles, and further including additionally moving the second row of tiles in the first direction, causing the second row of tiles to move in the first direction without causing a third, adjacent row of tiles to move, thereby distancing the second row of tiles from the third row of tiles, and withdrawing at least one tile from the second row of tiles from the front face of the array of tiles.

According to an aspect of some embodiments of the present invention there is provided a method for distancing adjacent tiles including using an actuator to move a first tile a first distance in a first direction without causing a second, adjacent, tile, mechanically connected to the first tile, to move, thereby distancing the first tile from the second tile.

According to some embodiments of the invention, further including using the actuator to additionally move the first tile a second distance in the first direction, causing the second tile to move in the first direction without causing a third, adjacent, tile, mechanically connected to the second tile, to move, thereby distancing the second tile from the third tile.

According to some embodiments of the invention, further including using the actuator to additionally move the first tile a third distance in the first direction, causing the second tile to move in the first direction, and causing the third tile to move.

According to some embodiments of the invention, the first tile includes a plurality of tiles and the second tile includes a plurality of second tiles.

According to some embodiments of the invention, the third tile includes a plurality of tiles.

According to an aspect of some embodiments of the present invention there is provided a method for removing a tile from an array of tiles including in an array of tiles which interfere with removing a first tile from the array moving the first tile far enough from a second tile which interferes with the removing so that the interference is anulled, and withdrawing the first tile from the array of tiles.

According to some embodiments of the invention, the interference with removing the first tile from the array of tiles is an interference selected from a group consisting of geometric interference caused by a shape of the tiles, friction between adjacent tiles, an overlap of a portion of a second tile with a portion of the first tile, an interlocking shape of the second tile and the first tile.

According to some embodiments of the invention, the first tile includes a module in an array of modules in an image display system.

According to some embodiments of the invention, the first tile includes a pixel in an array of pixels.

According to some embodiments of the invention, the withdrawing the first tile from the array of tiles includes withdrawing the first tile from a front face of the array of tiles.

According to some embodiments of the invention, the withdrawing the first tile from the array of tiles includes withdrawing the first tile from a back side of the array of tiles.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified illustration of tiles in a prior art display device;

FIG. 1B is a simplified illustration of another embodiment of a tile in a prior art display device;

FIG. 1C is a simplified illustration of an embodiment of a prior art tiled roof;

FIG. 2A is a simplified block diagram illustration of an example embodiment of the invention;

FIG. 2B is a simplified block diagram illustration of an example embodiment of the invention;

FIG. 3A is a simplified illustration of an example embodiment of the invention;

FIG. 3B is a simplified illustration of the example embodiment of FIG. 3A;

FIG. 3C is a simplified illustration of the example embodiment of FIG. 3A;

FIG. 3D is a simplified illustration of another example embodiment of the invention;

FIGS. 4A-D are simplified illustrations of an example embodiment of the invention;

FIG. 5A is a simplified flow chart illustration of an example embodiment of the invention;

FIG. 5B is a simplified flow chart illustration of an example embodiment of the invention;

FIG. 5C is a simplified flow chart illustration of an example embodiment of the invention;

FIG. 5D is a simplified flow chart illustration of an example embodiment of the invention; and

FIG. 5E is a simplified flow chart illustration of an example embodiment of the invention.

### DESCRIPTION OF SPECIFIC EMBODIMENTS OF THE INVENTION

The present invention, in some embodiments thereof, relates to distancing adjacent tiles and, more particularly, but not exclusively, to distancing adjacent overlapping tiles.

Overview

There are various devices and situations which include tiles adjacent to each other. The individual tiles may sometimes require maintenance, or replacement. In some cases, there is a need to access behind the tiles. However, in some cases it is difficult to pull out a tile or move a tile aside in order to reach a side or a back of the tile, or to reach behind the tile.

### Terminology

The term “tile” in all its grammatical forms is used throughout the present specification and claims to mean a unit in a one-dimensional or two-dimensional array of tiles. The term tile refers to a unit which can be pulled out and/or detached from the array of tiles.

The term module in all its grammatical forms is used throughout the present specification and claims to mean a unit in a one-dimensional or two-dimensional array of tiles.

An aspect of some embodiments of the invention relates to providing an ability to withdraw a tile from an array of tiles. In some embodiments, the array of tiles is constructed to form a wall, or attached to a wall.

In some embodiments the array of tiles is optionally partitioned into modules. In some embodiments the modules are optionally separable from each other

In some embodiments a tile may optionally be withdrawn from a front of face of the module.

In some embodiments the tiles overlap and/or interconnect along one or more sides.

Example Situations, Potential Difficulties

Some non-limiting examples of tiles in an array of tiles include:
An array of adjacent pixels in a display device, for example such as described in above-mentioned International Patent Application No. WO 2013/144956. In some cases a group of pixels may form one unit which may be extracted as a unit from the display device, and the group of pixels is what is termed a tile. In some cases a single pixel may form one unit which may be extracted as a unit from the display device, and the pixel is what is termed a tile.

A potential difficulty with maintaining such a display device can be replacing or maintaining a pixel (termed herein a tile) or a module (also termed herein a tile) which includes a group of pixels. In some cases, the tiles are attached to a wall, and can be accessed only from a front face, unless part of the device is unmounted from the wall. In some cases, such as in some embodiments described in above-mentioned International Patent Application No. WO 2013/144956, a tile overlaps an adjacent tile, so the adjacent tile cannot be pulled out of a front face of the display device.
Roof tiles or shingles, typically placed to overlap each other at the edges. Some roof tiles may be pulled out of an array of tiles by lifting one side, forming an angle between the tile and adjacent tiles, and pulling it out. However, in some case a tile is tied to a rafter, and some embodiments described herein describe how to move the rafters to which the tile(s) are connected in order to move the tiles apart and potentially make it possible to access the back of the tile(s) to disconnect one or more tiles.
A solar tile laid on a roof or attached to a wall. In some cases such a solar tile includes an electric attachment and/or an electric device attached to the solar tile. After laying solar tiles on a roof, it may be useful to move the tiles apart in order to access the electric attachment and/or the electric device. In some cases tiles are laid on a roof, limiting or preventing access to a back of the tile. In some cases tiles overlap, limiting access to one or more edges of an individual tile.
Blocks which are tiled adjacent to each other may be difficult to extract. Sometimes the depth of a block prevents tilting such a block in order to pull it out of an array of blocks.

Some Non-Limiting Example Solutions

An aspect of some embodiments of the invention relates to attaching a column or a two-dimensional array of tiles to a mechanism which opens a space between adjacent rows of tiles. In some embodiments, a first row of tiles, or a first tile of a column of tiles, is optionally translated to form a space between the first tile(s) and the next, second tile(s). In some embodiments, optional further translation forms a space between the second tile(s) and the next, third tile(s), and so on.

In some embodiments a first tile is linked to a second tile, with a link which allows the first tile to move away from the second tile. In some embodiments, after the first tile moves a specific distance away from the second tile, the link engages the second tile, and further movement of the first tile in a same direction pulls the second tile, potentially away from a third tile, and so on.

In some embodiments a first row of tile is attached to a first rod or rafter which is attached to one or more tiles in a first row of tiles. The first rod is optionally caused to advance in a direction away from a second rod, to which are attached on or more of a second row of tiles, optionally distancing the first row from the second row. In some embodiments, after the first rod moves a specific distance, a link attached to the first rod optionally engages the second rod, and further movement of the first rod in a same direction pulls the second rod, and the second row of tiles, away from a third rod and a third row of tiles, and so on.

Some Non-Limiting Examples of Types of Tiles

Pixels in a display device, roof tiles, solar tiles, solar panels, escalator stairs, paving blocks.

Some Non-Limiting Examples of Arrays of Tiles

A multi-pixel display device, a tiled roof, a roof tiled with solar tiles, an arrangement of solar panels, an escalator, a street or sidewalk tiled with paving blocks.

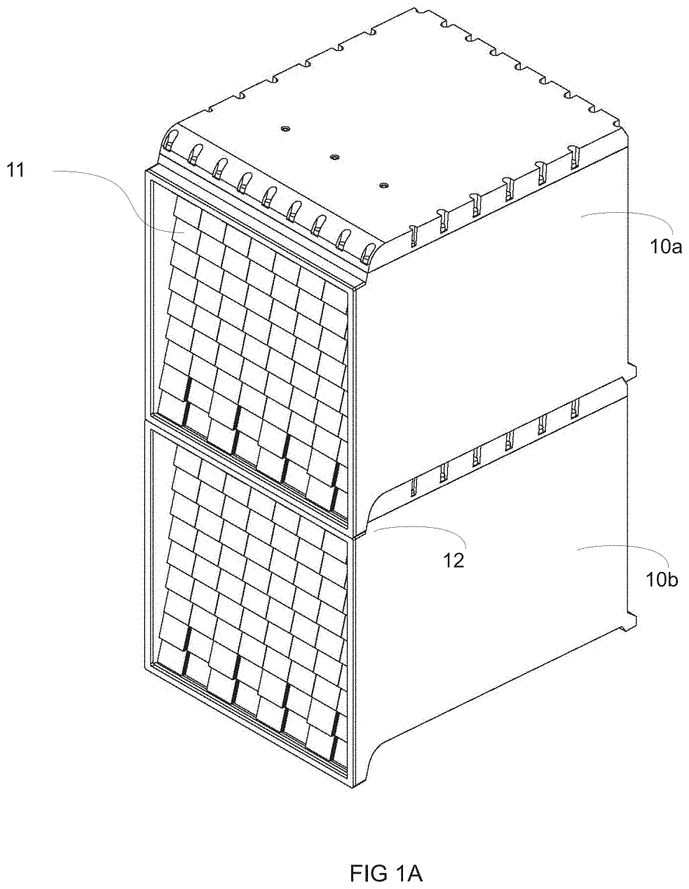

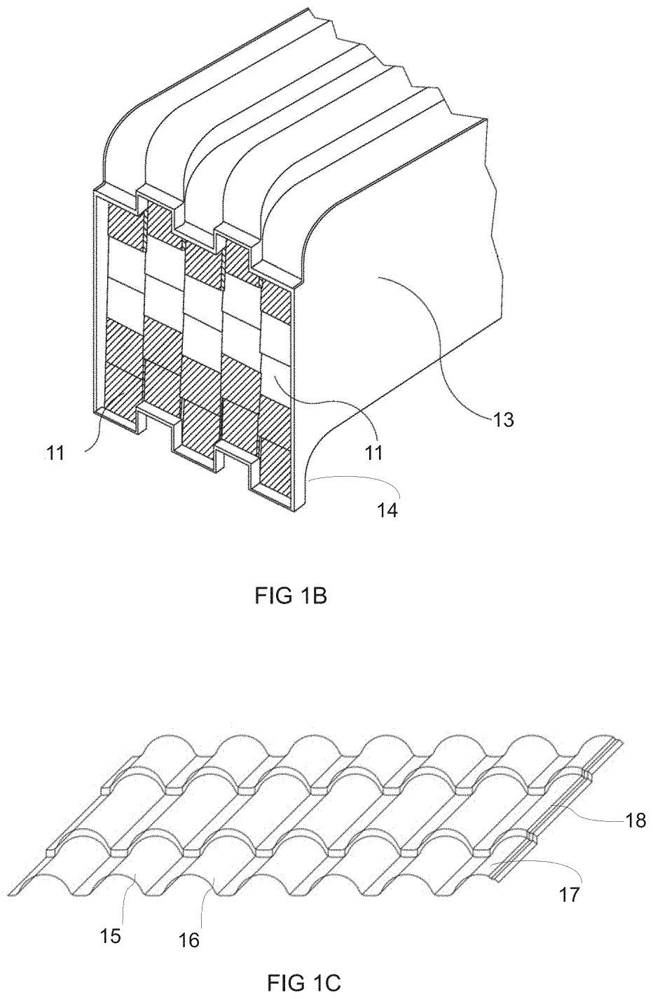

For purposes of better understanding some embodiments of the present invention, reference is first made to the construction of tiles in a prior art display device as illustrated in FIG. 1A.

Reference is now made to FIG. 1A, which is a simplified illustration of tiles in a prior art display device.

FIG. 1A shows a pair of overlapping tiles 10a 10b, for example as described in above-mentioned International Patent Application No. WO 2013/144956. Each of the tiles 10a 10b is a module which includes pixels 11 for displaying an image. The tiles 10a 10b are typically attached to a wall, potentially on a side of a building, or as a street display.

FIG. 1A shows the tiles 10a 10b with an overlap 12 of a first tile 10a on a second tile 10b. In some embodiments the overlap 12 enables tiling an array of such tiles 10a 10b, producing a large display device.

It is noted that tile 10b cannot be pulled forward because of the overlap 12 of tile 10a blocking its way.

Reference is now made to FIG. 1B, which is a simplified illustration of another embodiment of a tile in a prior art display device.

FIG. 1B shows a tile 13, for example as described in above-mentioned International Patent Application No. WO 2013/144956. The tile 13 includes pixels 11 for displaying an image. FIG. 1B shows the tile 13 having staggered row of pixels 11, and an optional staggered overlap 14 for overlapping a neighboring tile.

Reference is now made to FIG. 1C, which is a simplified illustration of an embodiment of a prior art tiled roof.

FIG. 1C shows tiles 15 16 in a tiled roof. In some cases the tiles 15 16 are separate, and are mounted separately on the roof. In some cases an entire row of tiles 17 18 is fabricated in one piece.

The tiles 15 16 are usually partly overlapping.

The rows of tiles 17 18 are usually partly overlapping.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

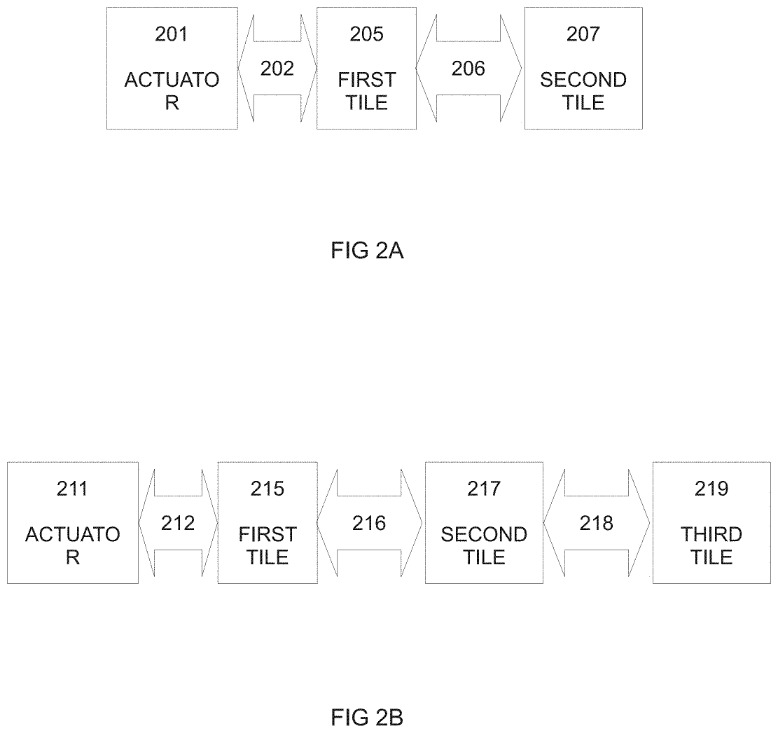

Reference is now made to FIG. 2A, which is a simplified block diagram illustration of an example embodiment of the invention.

FIG. 2A shows an actuator 201, mechanically connected 202 to a first tile 205, which is connected by a mechanical link 206 to a second tile 207.

In some embodiments, the mechanical link 206 is configured to enable the actuator 201 to move the first tile 202 a first distance in a first direction without causing the second tile 207 to move, and to cause the second tile 207 to move in the first direction when the first tile 205 is moved in the first direction further than the first distance.

In some embodiments, the first tile 205 includes several tiles.

In some embodiments, the first tile 205 includes a first row of tiles.

In some embodiments, the second tile 207 includes several tiles.

In some embodiments, the second tile 207 includes a second row of tiles.

In some embodiments the actuator is an electric actuator designed to move the first tile linearly in the first direction.

In some embodiments the actuator is a hydraulic actuator designed to move the first tile linearly in the first direction.

In some embodiments the mechanical link 206 includes a slot which enables the first tile 205 to move the first distance before engaging the second tile 207.

Reference is now made to FIG. 2B, which is a simplified block diagram illustration of an example embodiment of the invention.

FIG. 2B shows an actuator 211, mechanically connected 212 to a first tile 215, which is connected by a first mechanical link 216 to a second tile 217, which is connected by a second mechanical link 218 to a third tile 219.

In some embodiments, the first mechanical link 216 is configured to enable the actuator 211 to move the first tile 212 a first distance in a first direction without causing the second tile 217 to move, and to cause the second tile 217 to move in the first direction when the first tile 215 is moved in the first direction further than the first distance.

In some embodiments, the second mechanical link 218 is configured to enable the second tile 217 to move a second distance in the first direction without causing the third tile 219 to move, and to cause the third tile 219 to move in the first direction when the second tile 217 is moved in the first direction further than the second distance.

In some embodiments, the first tile 215 includes several tiles.

In some embodiments, the first tile 215 includes a first row of tiles.

In some embodiments, the second tile 217 includes several tiles.

In some embodiments, the second tile 217 includes a second row of tiles.

In some embodiments, the third tile 219 includes several tiles.

In some embodiments, the third tile 219 includes a third row of tiles.

In some embodiments the actuator is an electric actuator designed to move the first tile linearly in the first direction.

In some embodiments the actuator is a hydraulic actuator designed to move the first tile linearly in the first direction.

In some embodiments the first mechanical link 216 includes a slot which enables the first tile 215 to move the first distance before engaging the second tile 217.

In some embodiments the second mechanical link 218 includes a slot which enables the second tile 217 to move the second distance before engaging the third tile 219.

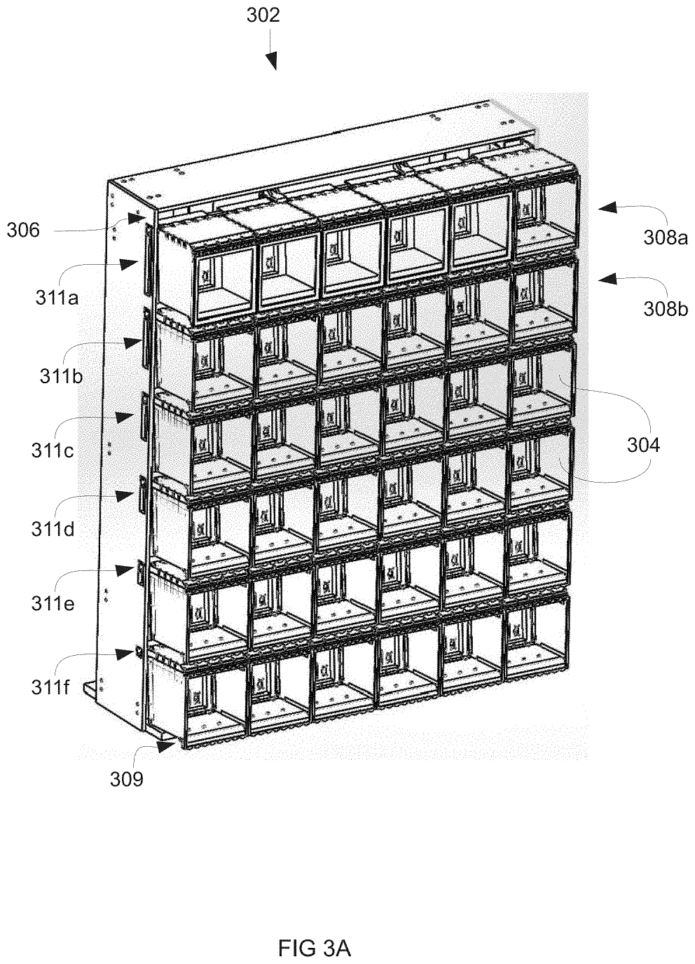

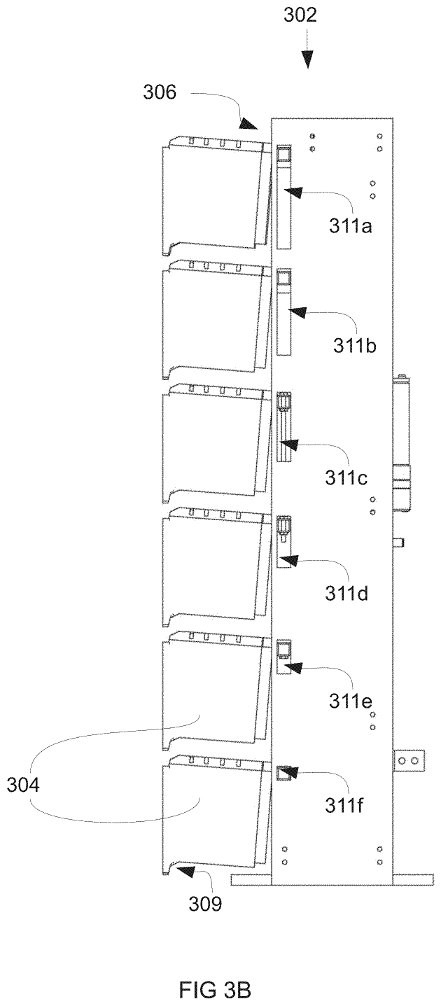

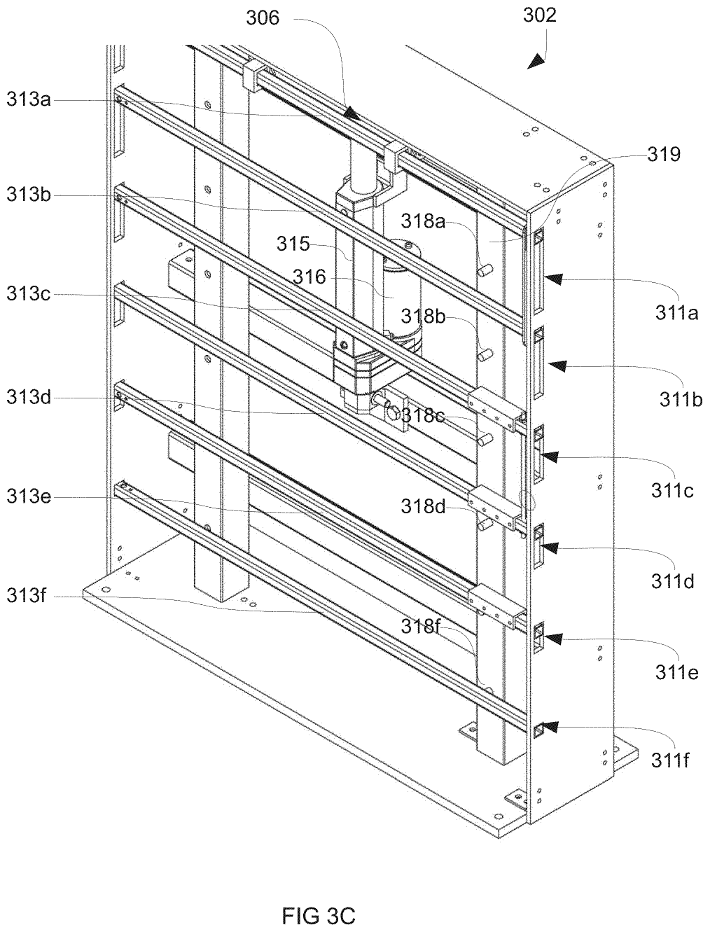

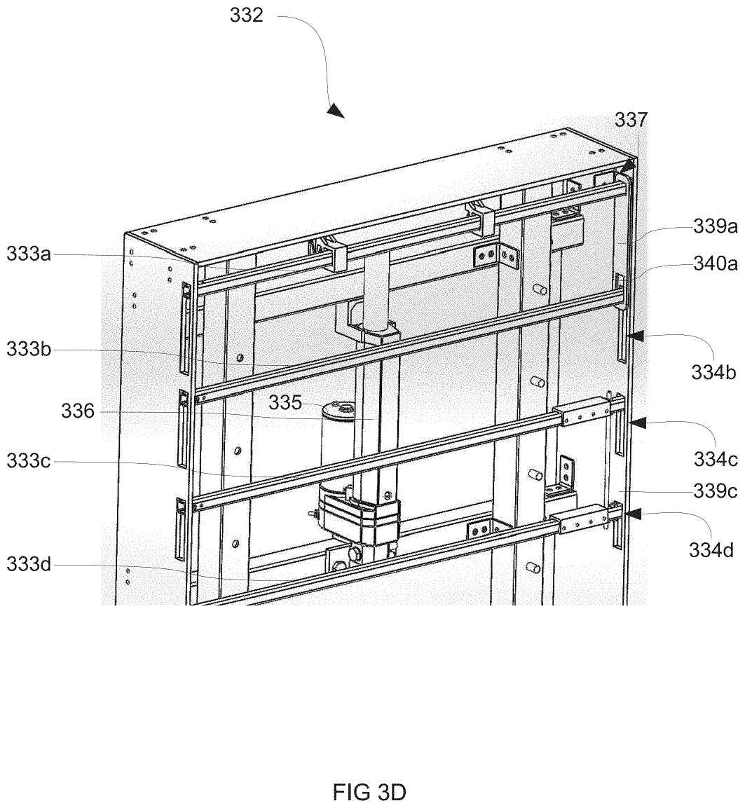

Reference is now made to FIG. 3A, which is a simplified illustration of an example embodiment of the invention.

FIG. 3A shows an example embodiment of a module 302 with 6×6 tiles 304.

In some embodiments the module optionally has an open space 306 at one edge, optionally at a top edge, of the module 302. The open space is optionally wide enough for moving at least one row of modules toward the top edge, enough to open a space between a first row 308a of tiles and a second, adjacent row 308b of tiles.

In some embodiments the first row 308a of tiles optionally overlaps the second row of tiles 308b, and optionally so on each row.

In some embodiments a last row 308f of tiles does not overlap a bottom of the module 302.

In some embodiments the last row 308f of tiles does overlap a bottom of the module 302, as pointed out by reference number 309.

In some embodiments the open space 306 is as wide as a width of an overlap 309, potentially enabling translating the first row 308a of tiles far enough so as not to overlap the second row of tiles, thus enabling pulling out one or more tiles in the second row 308b of tiles from a forward face of the module 302.

In some embodiments the second row 308b may optionally be translated far enough so as not to overlap a third row of tiles, thus enabling pulling out a tile in the third row of tiles from a forward face of the module 302.

In some embodiments additional rows may optionally be translated far enough so as not to overlap some lower row of tiles, thus enabling pulling out a tile in a lower row of tiles from a forward face of the module 302.

In some embodiments the open space 306 is as wide as N−1 widths of an overlap 309 in an N row by M column array of tiles, potentially enabling translating all the N rows away from each other, opening up N−1 spaces with a width of the overlap 309, far enough so as to prevent all the rows of tiles from overlapping their neighbor rows, potentially enabling pulling out one or more tiles in any row of tiles from a forward face of the module 302.

In some embodiments side walls of the module 302 optionally include slots 311a, 311b, 311c, 311d, 311e, 311f which guise and/or limit a range of movement of each row of tiles.

In some embodiments the slots have different lengths.

In some embodiments a length of a first slot 311a is optionally N−1 widths of the overlap 309, optionally enabling translating the first row of tiles 308a by N−1 widths of the overlap 309; a length of a second slot 311b is optionally N−2 widths of the overlap 309, optionally enabling translating the second row of tiles 308b by N−2 widths of the overlap 309, and so on, until a slot having a length equal to one width of the overlap 309.

Reference is now made to FIG. 3B, which is a simplified illustration of the example embodiment of FIG. 3A.

FIG. 3B shows a side view of the module 302 with 6×6 tiles 304.

The side view shows the tiles 304 having the optional overlap 309.

The side view also shows the slots 311a, 311b, 311c, 311d, 311e, 311f having optionally differing lengths.

Reference is now made to FIG. 3C, which is a simplified illustration of the example embodiment of FIG. 3A.

FIG. 3C is an isometric illustration of the module 302, with the tiles left out of the illustration in order to show some optional features in the example embodiment.

FIG. 3C shows optional rods 313a-f to which each row of tiles is optionally attached.

FIG. 3C also shows an actuator 316 configured to act on the top rod 313a by an optional connecting member 315. In some embodiments the actuator 316 is an electric motor. In some embodiments the actuator 316 and/or the connecting member 315 are implemented by a hydraulic actuator.

In some embodiments the actuator 316 is configured to translate the top rod 313a toward a top of the module 302, into the space 306.

In some embodiments movement of the top rod 313a is optionally first without effecting movement of lower rods 313b-f, then effecting movement of one lower rod 313b, later another lower rod 313c, and so on.

In some embodiments the rods 313a-f each move in its own slot, of the slots 311a-f.

In some embodiments the lengths of the slots 311a-f is different for each slot, according to a desired range of movement for the rod 313a-f corresponding to the slot 311a-f.

In some embodiments the actuator 316 is attached to an optional slat 319, which is attached to the top rod 313a, the slat 319 being configured to be moved up and down along the module 302 by the actuator 316.

In some embodiments, the slat 319 optionally includes pegs 318a-f, placed along the slat 319 at positions configured to engage each one of the rods 313a-f at a different location along the movement of the slat 319.

In some embodiments, when the slat 319 is moved up and down along the module 302, the pegs 318a-f engage the rods 313a-f at such positions as to first open a space between a first row of tiles and a second row of tiles, then, upon further movement in the same direction, open a space between the second row of tiles and a third row of tiles, and so on.

Reference is now made to FIG. 3D, which is a simplified illustration of another example embodiment of the invention.

FIG. 3D is an isometric illustration of a module 332, with tiles left out of the illustration in order to show some optional features in the example embodiment.

FIG. 3D shows optional rods 333a-d to which each row of tiles is optionally attached.

FIG. 3D also shows an actuator 336 configured to act on the top rod 333a by an optional connecting member 335. In some embodiments the actuator 336 is an electric motor. In some embodiments the actuator 336 and/or the connecting member 335 are implemented by a hydraulic actuator.

In some embodiments the actuator 336 is configured to translate the top rod 333a toward a top of the module 332, into a space 337.

In some embodiments movement of the top rod 333a is optionally first without effecting movement of lower rods 333b-d, then effecting movement of one lower rod 333b, later another lower rod 333c, and so on.

In some embodiments the rods 333a-d each move in its own slot, of optional slots 334a-d (slot 334a is not seen in FIG. 3D).

In some embodiments the lengths of the slots 334a-d is different for each slot, according to a desired range of movement for the rod 333a-d corresponding to the slot 334a-d.

In some embodiments the top rod 333a is attached to an optional connecting member 339a, which is attached to the second rod 333b, the connecting member 339a being configured to be moved up and down by the top rod 333a.

In some embodiments the connecting member 339a includes a slot 340a, which enables the top rod 333a to move a desired distance before engaging the second rod 333b and moving the second rod 333b.

In some embodiments additional optional connecting members attach one rod of the rods 333a-d to a rod one below, of the rods. For example, FIG. 3D shows an optional connecting member 339c, connecting the third rod 333c to the fourth rod 333d. Not all optional connecting members are shown in order not to obscure additional features in FIG. 3D. A person skilled in the art will extrapolate from the description of the connecting member 339a how additional optional connecting members transfer movement from a higher rod of the rods 333a-d to a next-lower rod of the rods 333a-d.

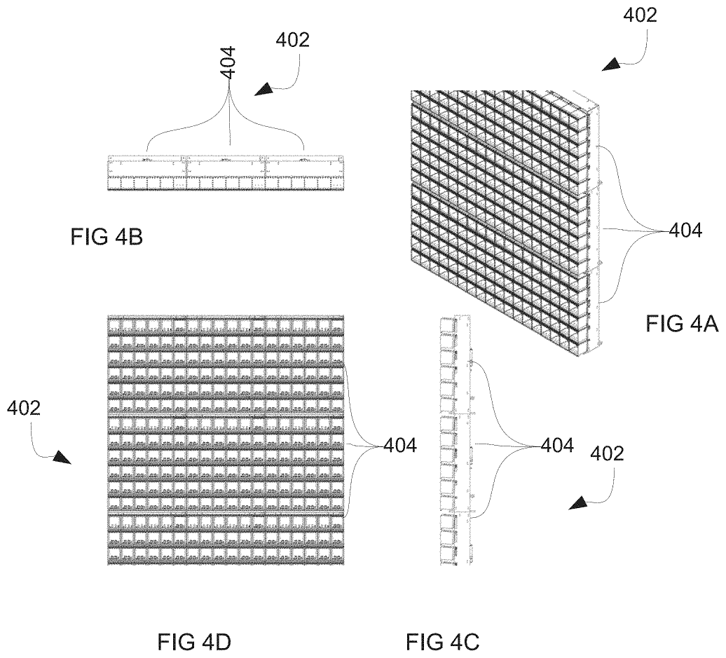

Reference is now made to FIGS. 4A-D, which are simplified illustrations of an example embodiment of the invention.

FIGS. 4A-4D shows a display system 402 including 3×3 plates 404, each plate 404 including several rows of tiles, by way of a non-limiting example, such as described with reference to FIGS. 2A-2B and 3A-3D.

FIG. 4A is an isometric view, FIG. 4B is a top view, FIG. 4C is a side view and FIG. 4D is a front view of the example embodiment display system 402.

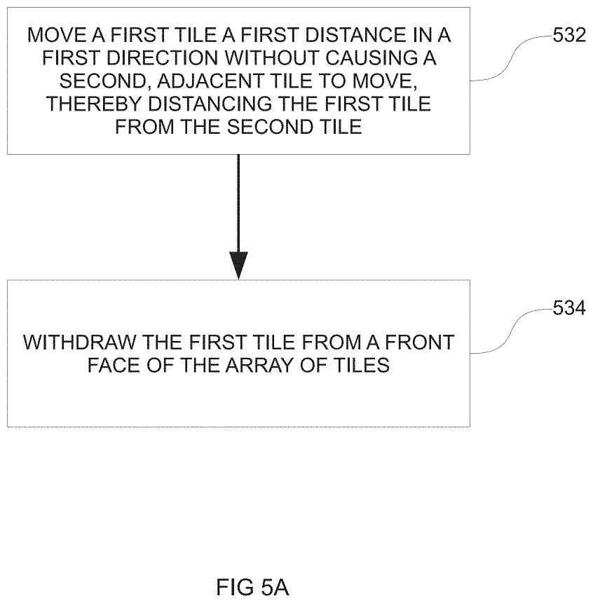

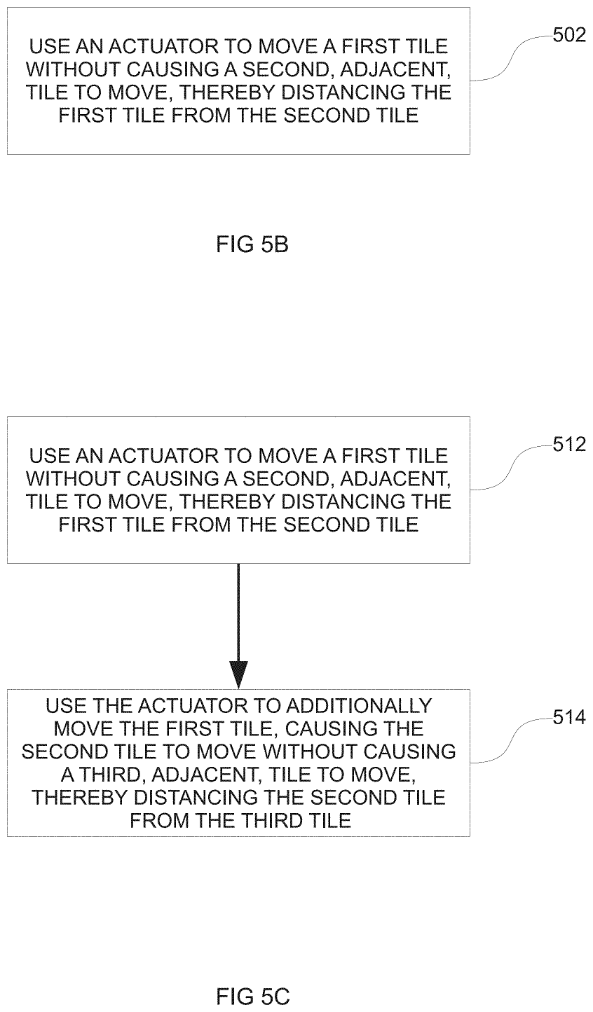

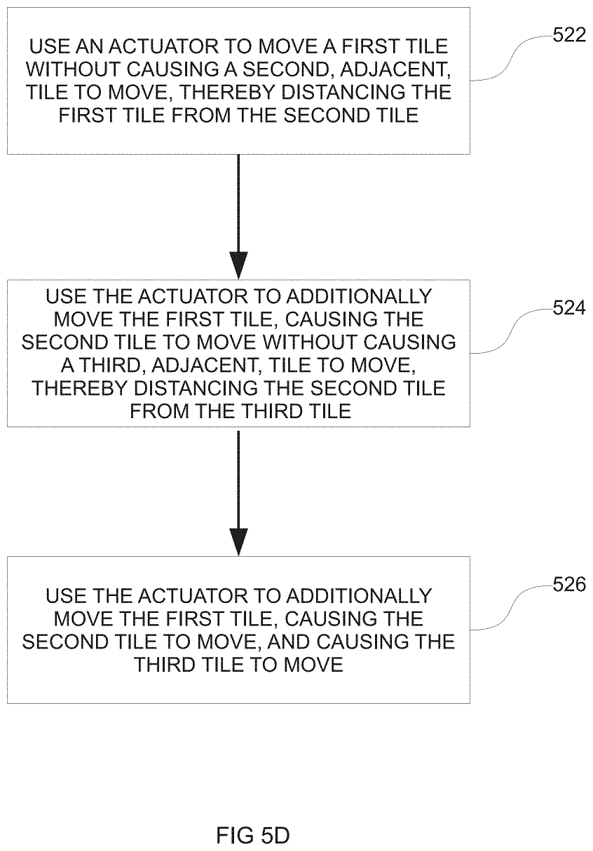

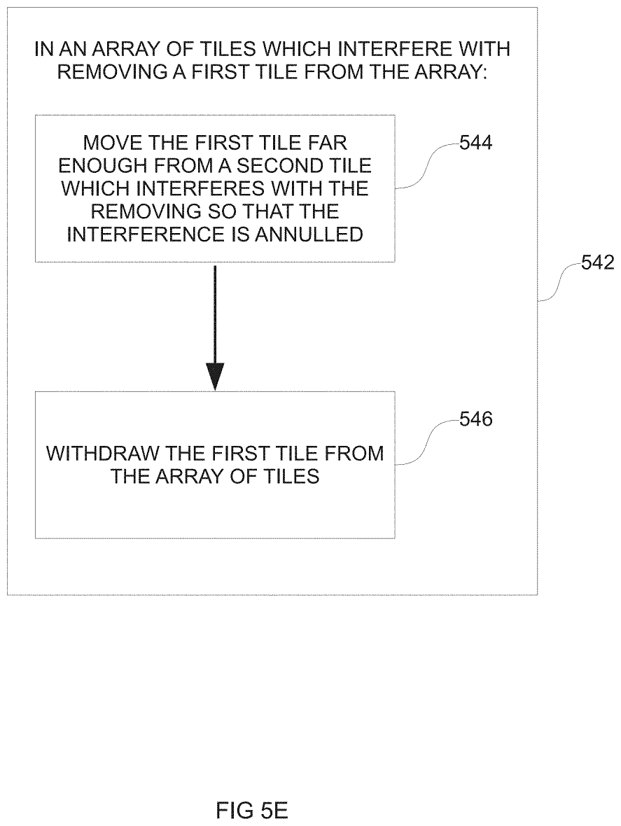

Reference is now made to FIG. 5A, which is a simplified flow chart illustration of an example embodiment of the invention.

FIG. 5A shows a method for withdrawing a tile from an array of tiles including:

moving a first tile a first distance in a first direction without causing a second, adjacent tile to move, thereby distancing the first tile from the second tile (532); and

withdrawing the first tile from a front face of the array of tiles (534).

In some embodiments, additional actions are optionally taken, including:

additionally moving the second tile in the first direction, causing the second tile to move in the first direction without causing a third, adjacent tile to move, thereby distancing the second tile from the third tile; and

withdrawing the second tile from the front face of the array of tiles.

In some embodiments the above-described first tile is a first row of tiles.

In some embodiments the above-described second tile is a second row of tiles.

In some embodiments the withdrawing the first tile from a front face of the array of tiles comprises withdrawing at least one tile from the first row of tiles.

In some embodiments additional actions are optionally taken, including moving the second row of tiles further in the first direction, causing the second row of tiles to move in the first direction without causing a third, adjacent row of tiles to move, thereby distancing the second row of tiles from the third row of tiles.

In some embodiments additional actions are optionally taken including withdrawing at least one tile from the second row of tiles from the front face of the array of tiles.

Reference is now made to FIG. 5B, which is a simplified flow chart illustration of an example embodiment of the invention.

FIG. 5B shows a method for distancing adjacent tiles including using an actuator to move a first tile a first distance in a first direction without causing a second, adjacent, tile, mechanically connected to the first tile, to move, thereby distancing the first tile from the second tile (502).

In some embodiments the method of FIG. 5B further includes additional features.

Reference is now made to FIG. 5C, which is a simplified flow chart illustration of an example embodiment of the invention.

FIG. 5C shows a method for distancing adjacent tiles including:

using an actuator to move a first tile a first distance in a first direction without causing a second, adjacent, tile, mechanically connected to the first tile, to move, thereby distancing the first tile from the second tile (512); and

using the actuator to additionally move the first tile a second distance in the first direction, causing the second tile to move in the first direction without causing a third, adjacent, tile, mechanically connected to the second tile, to move, thereby distancing the second tile from the third tile (514).

In some embodiments the method of FIG. 5C further includes additional features.

Reference is now made to FIG. 5D, which is a simplified flow chart illustration of an example embodiment of the invention.

FIG. 5D shows a method for distancing adjacent tiles including:

using an actuator to move a first tile a first distance in a first direction without causing a second, adjacent, tile, mechanically connected to the first tile, to move, thereby distancing the first tile from the second tile (522);

using the actuator to additionally move the first tile a second distance in the first direction, causing the second tile to move in the first direction without causing a third, adjacent, tile, mechanically connected to the second tile, to move, thereby distancing the second tile from the third tile (524); and

using the actuator to additionally move the first tile a third distance in the first direction, causing the second tile to move in the first direction, and causing the third tile to move (526).

Reference is now made to FIG. 5E, which is a simplified flow chart illustration of an example embodiment of the invention.

FIG. 5E shows a method for removing a tile from an array of tiles.

The method illustrated by FIG. 5E includes:

in an array of tiles which interfere with removing a first tile from the array (542):

moving the first tile far enough from a second tile which interferes with the removing so that the interference is annulled (544); and

withdrawing the first tile from the array of tiles (546).

In some embodiments, the interference with removing the first tile from the array of tiles is caused by one or more of:

geometric interference caused by a shape of the tiles;

friction between adjacent tiles;

an overlap of a portion of a second tile with a portion of the first tile; and

an interlocking shape of the second tile and the first tile.

In some embodiments, the first tile is a module in an array of modules in an image display system.

In some embodiments, wherein the first tile is a pixel in an array of pixels.

In some embodiments, the withdrawing the first tile from the array of tiles is performed from a front face of the array of tiles.

In some embodiments, the withdrawing is performed from a back side of the array of tiles.

It is expected that during the life of a patent maturing from this application many relevant elements suitable for tiling will be developed and the scope of the term tile is intended to include all such new technologies a priori.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system comprising:
a first tile;
an actuator mechanically connected to the first tile; and
a mechanical link mechanically connecting the first tile to a second tile,
wherein the mechanical link is configured:
to allow the actuator to move the first tile a first distance in a first direction without causing the second tile to move; and
to cause the second tile to move in the first direction when the first tile is moved in the first direction further than the first distance.

2. The system of claim 1 wherein:
the actuator is mechanically connected to a first rod; and
the first rod is connected to the first tile.

3. The system of claim 2 and further comprising a second rod and wherein the mechanical link mechanically connects the first rod to the second rod.

4. The system of claim 3 and further comprising a third rod and a second mechanical link, and wherein:
the third rod is connected to a third tile;
the second mechanical link mechanically connects the second rod to the third rod; and
the second mechanical link is configured:
to allow the second rod to move the second tile a second distance in the first direction without causing the third rod to move; and
to cause the third rod to move in the first direction when the second rod is moved in the first direction further than the second distance.

5. The system of claim 1 wherein the first tile comprises a plurality of tiles and the second tile comprises a plurality of second tiles.

6. The system of claim 4 wherein the third tile comprises a plurality of tiles.

7. The system of claim 1 wherein at least the first tile comprises a module in an array of display modules in a display system.

8. The system of claim 1 wherein at least the first tile comprises a pixel in an array of pixels in a display system.

9. A method for distancing adjacent tiles comprising:
using an actuator to move a first tile of an array of tiles a first distance in a first direction without causing a second, adjacent, tile, mechanically connected to the first tile, to move, thereby distancing the first tile from the second tile.

10. The method of claim 9 and further comprising withdrawing the first tile from a front face of the array of tiles.

11. The method of claim 10 wherein:
the first tile comprises a first row of tiles;
the second tile comprises a row of second row of tiles; and
the withdrawing the first tile from a front face of the array of tiles comprises withdrawing at least one tile from the first row of tiles.

12. The method of claim 9 wherein:
the first tile comprises a first row of tiles;
the second tile comprises a row of second row of tiles,
and
further comprising additionally moving the second row of tiles in the first direction, causing the second row of tiles to move in the first direction without causing a third, adjacent row of tiles to move, thereby distancing the second row of tiles from the third row of tiles; and
withdrawing at least one tile from the second row of tiles from the front face of the array of tiles.

13. The method of claim 9 and further comprising using the actuator to additionally move the first tile a second distance in the first direction, causing the second tile to move in the first direction without causing a third, adjacent, tile, mechanically connected to the second tile, to move, thereby distancing the second tile from the third tile.

14. The method of claim 13 and further comprising withdrawing the second tile from the front face of the array of tiles.

15. The method of claim 13 and further comprising using the actuator to additionally move the first tile a third distance in the first direction, causing the second tile to move in the first direction, and causing the third tile to move.

16. The method of claim 9 wherein the first tile comprises a plurality of tiles and the second tile comprises a plurality of second tiles.

17. The method of claim 13 wherein the third tile comprises a plurality of tiles.

18. A method for removing a tile from an array of tiles comprising:
in an array of tiles which interfere with removing a first tile from the array:
moving the first tile far enough from a second tile which interferes with the removing so that the interference is anulled; and
withdrawing the first tile from the array of tiles.

19. The method of claim 18, wherein the interference with removing the first tile from the array of tiles is an interference selected from a group consisting of:
geometric interference caused by a shape of the tiles;
friction between adjacent tiles;
an overlap of a portion of a second tile with a portion of the first tile;
an interlocking shape of the second tile and the first tile.

20. The method of claim 18 wherein the withdrawing the first tile from the array of tiles comprises withdrawing the first tile from a back side of the array of tiles.
